(19) United States
(12) Patent Application Publication
(10) Pub. No.: US 2005/0056579 A1
(43) Pub. Date: Mar. 17, 2005

(54) Water magnetizer

(76) Inventor: John Andrew Hodgson, Safety Harbor, FL (US)

Correspondence Address: JOHN ANDREW HODGSON, 340 6th STREET NORTH, SAFETY HARBOR, FL, 34695, US

(21) Appl. No.: 10/810,178

(22) Filed: Oct. 29, 2004

Related U.S. Application Data
(60) Provisional application No. 60/459,404, filed on Apr. 1, 2003.

(51) Int. Cl. B03C 1/02

(52) U.S. Cl. 210/222

(57) ABSTRACT

This invention is a new phenomena of the creation of enhanced water, with using electromagnetic scalar waves, upon drinking or absorption or assimilation of the enhance water, a enhanced biological functions occur as a result of drinking, absorption and assimilation of the enhanced water.

### BACKGROUND OF THE INVENTION

This invention relates to enhancement of water with active electromagnetic scalar waves, and the biological enhancement resulting from the absorption of the enhanced water to biological organism.

### SUMMARY OF THE INVENTION

It is an object of the invention to provide a new and unexpected biological result from the process of magnetizing water with electromagnetic and electromagnetic scalar waves.

1. Object of the invention is to provide a method of enhancement of biological function for plant, animal, mammal and human consumption, absorption, and assimilation of magnetized water to support, restore, re-create and give life assistance to plant, animal, mammal and human body to repair, rejuvenate and sustain life.

2. The invention comprises a method for treating water with scalar electromagnetic wave energy to create a magnetized water inside a vessel that supports water to be energized

3. The invention uses scalar electromagnetic forces to create magnetic inductive nulls within the water vessel.

4. The inventions uses electromagnetic forces to create scalar waves within the support structure of vessel

The inventors best method of creating magnetized water is a power supply that uses appropriate source voltage 115 vac united states standard or 220 vac international standard to supply a dc voltage to the two oscillator circuits of the invention, an oscillator circuit that the tank circuit has wiring containing electromagnetic forces along a external wiring from the circuit board to the water within the water vessel, both electrical loops are opposed to each other with angles of incidence (two loop wiring cage) to induce electromagnetic scalar waves inside the water to be magnetized

### DETAILED DESCRIPTION OF THE DRAWINGS

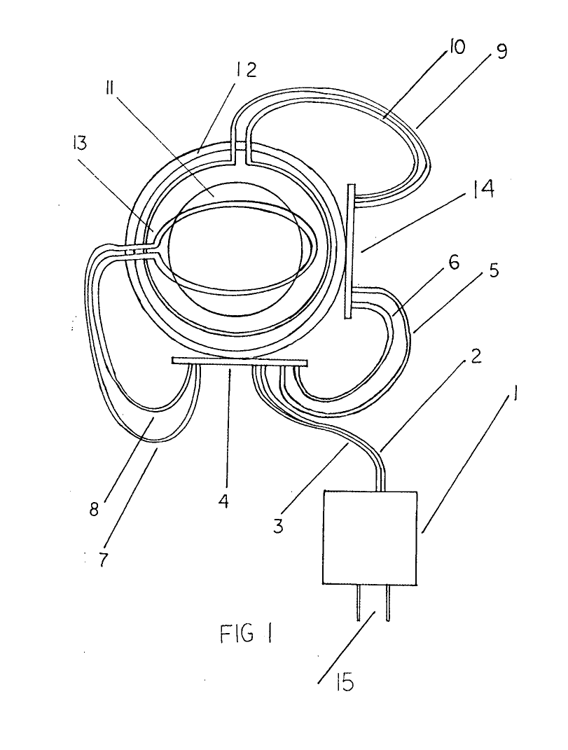

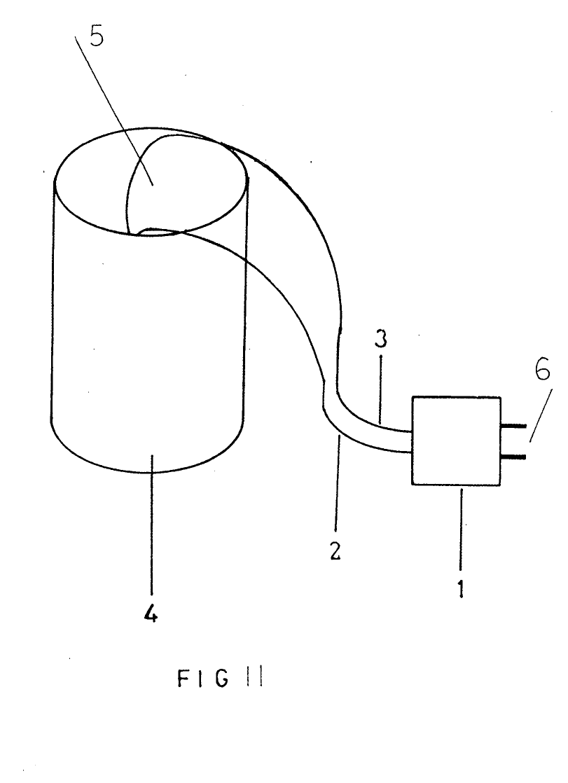

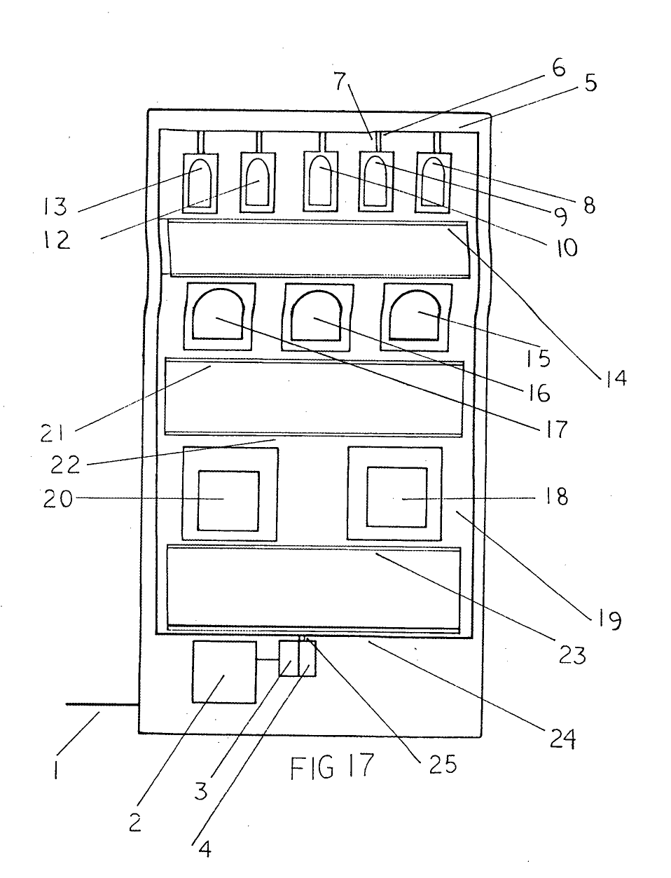

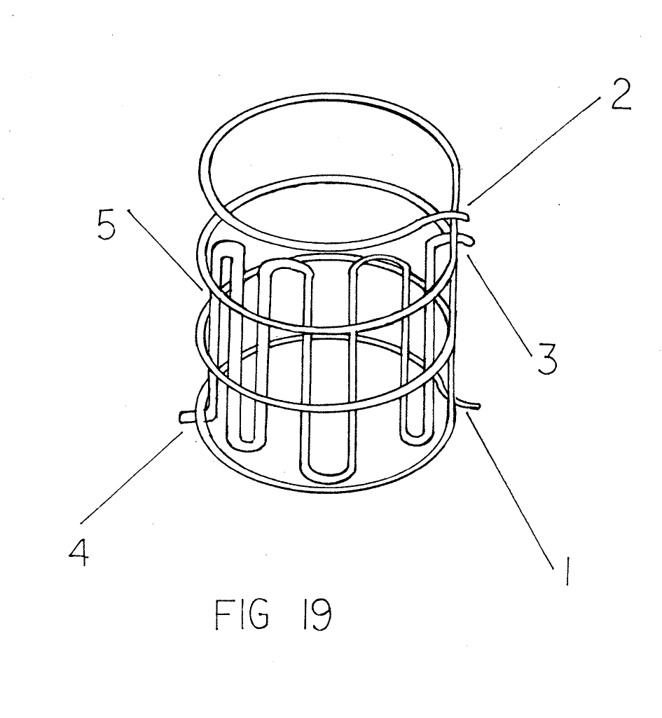

FIG. 1 num 1 is a power supply that takes provided external power and converts that power to a suitable electrical voltage to drive the oscillator FIG. 1 num 4. FIG. 1 num 5 and FIG. 1 num 6 are the jumpers that provide power from the 1^{st} circuit board to the 2^{nd} oscillator circuit board that will create the electromagnetic induction along the insulated wiring. FIG. 1 num 7 and FIG. 1 num 8 and FIG. 1 num 9 and FIG. 1 num 10, are the electrical loops to provide electromagnetic fields to create induction to the water provided in FIG. 1 num 12. FIG. 17 and 8 are placed at a incidence angle with electrical loops FIG. 19 and 10 to induce electromagnetic scalar waves inside the provided vessel FIG. 1 num 12. FIG. 1 num 14 is the 2^{nd} oscillator. FIG. 1 number 4 is the 1^{st} oscillator.

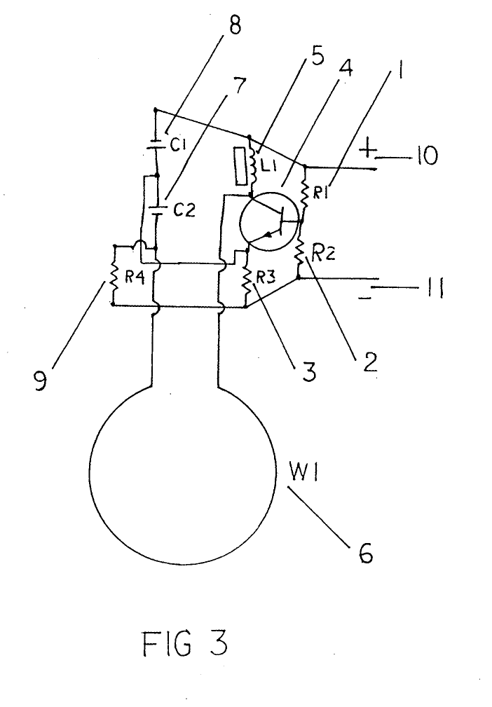

FIG. 3 number 1 r1 and FIG. 3 number 2 r2 are a voltage dividing resistor network to supply voltage to the oscillator circuitry. FIG. 3 num 3 r3 is the emitter transistor resistor voltage to provide voltage to the emitter of the npn transistor. FIG. 3 num 4 is the npn transistor that provides the change in voltage that will create the oscillator tank frequency. FIG. 3 num 5 11 is the electrical inductor that helps create the frequency tank circuit. FIG. 3 num 6 w1 is the external wiring that is part of the electrical oscillator tank frequency that provides the electromagnetic induction with the water that is provided in the vessel that is shown as FIG. 1 num 12. FIG. 3 num 7 c2 is a capacitor that helps create the oscillator tank frequency. FIG. 3 num 8 c1 is a capacitor that helps create the oscillator tanks frequency. FIG. 3 num 9 r4 is a resistor that helps create a voltage across the tank circuit to the electrically negative charged voltage provided from the power supply FIG. 1 num 1. FIG. 3 num 10 is a means to provide positive voltage to the oscillator, FIG. 3 num 11 is a means to provide negative voltage to the oscillator, FIG. 3 num 10 is a electrical conductive wiring that provides positive voltage from the power supply FIG. 1 num 1, FIG. 3 num 11 is a electrical conductive wiring that provides negative voltage from the power supply, FIG. 3 num 10 also has a non conductive electrical insulation that provides insulation across the electrical wiring, FIG. 3 number 10 also has a non conductive electrical insulation that provides insulation across the electrical wiring FIG. 3 num 6 w1 is the electrical conduction wiring that is surrounded with a non conducting electrical wiring. This external wire is part of the oscillator tank circuit comprising and 11, c1, c2, and this tank circuit provides the electromagnetic fields along the wiring FIG. 3 num 6 w1 to the vessel FIG. 1 num 12 that contains the water to be magnetized. The two electrical loops FIG. 1 number 7 and 8 plus FIG. 1 number 9 and 10 are shown with a angle of incidence FIG. 1 number 13 that shows the two electrical wires are placed to create electromagnetic scalar waves nullification and induction with the water in the vessel FIG. 1 number 12. Both electromagnetic oscillator circuits FIG. 1 number 4 and fig 1 number 14 are using the same electrical components to create electromagnetic waves nullification and induction of same approximate frequency to cancel each other out with the appropriate polarities of the two electromagnetic waves being combined with the water in the vessel FIG. 1 number 12. FIG. 1 number 11 is the bottom of the vessel that contains the water to be magnetized. FIG. 1 number 15 is the prongs that connect the power supply to an appropriate outlet

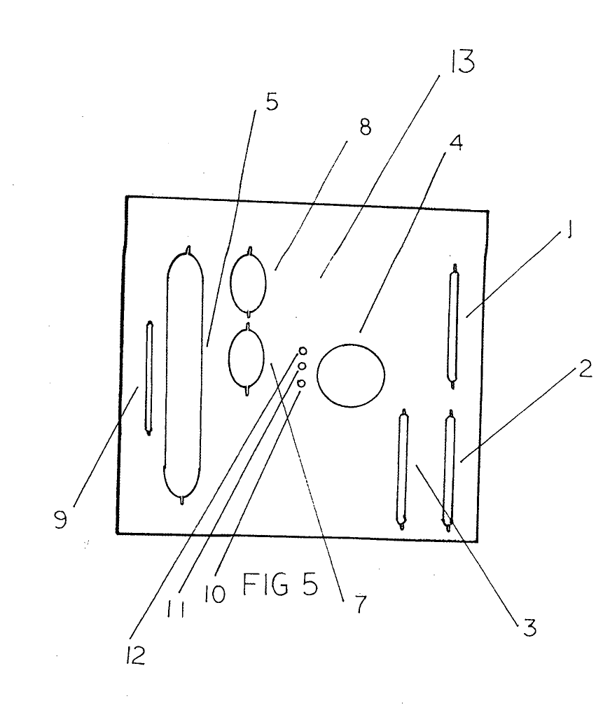

FIG. 5 num 1 is a resistor to provide voltage divider network, FIG. 5 num 2 is a resistor to provide voltage divider network, FIG. 5 num 3 is the npn emitter resister to provide voltage to npn transistor. FIG. 5 num 4 is a npn transistor to create the oscillations in the circuit board, FIG. 5 num 7 is a capacitor to create the oscillations in the circuit board, FIG. 5 num 8 is a capacitor to create oscillations in the circuit board, FIG. 5 num 5 is a inductor to create oscillation frequency in the circuit board, FIG. 5 num 9 is a resistor to develop voltage in the circuit board, FIG. 5 num 10 is the hole in the circuit board for the emitter leg of the transistor to be place through, FIG. 5 num 11 is the hole that the base of the transistor leg to be placed though, FIG. 5 num 12 is the hole that the collector of the transistor leg is to be placed though. FIG. 5 num 13 is a circuit board that supports the electronic components.

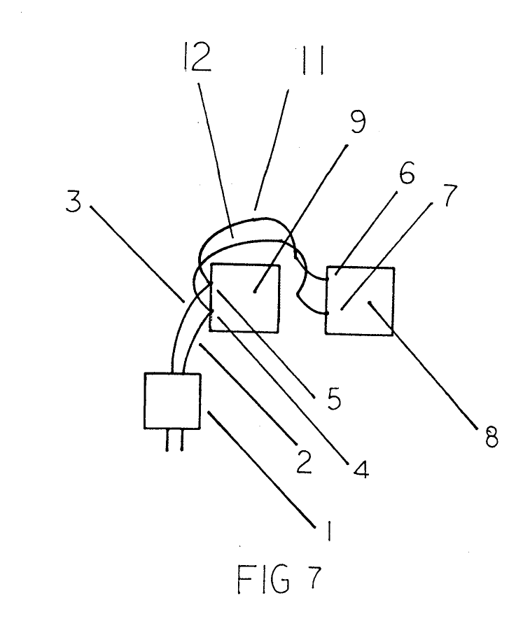

FIG. 7 num 1 is a power supply that provides direct current voltage to the two oscillator boards, the FIG. 7 num 1 has a alternate current input voltage that is provided externally to the invention, FIG. 7 num 1 is also an on off virtual switch by disconnection and reconnection from a appropriate socket, FIG. 7 num 2 is the positive voltage wiring to the circuit board, FIG. 7 num 3 is the negative voltage wiring to the circuit board, FIG. 7 num 4 is the common jumper point that connects the positive voltage from 1st oscillator board to the 2^{nd} oscillator board, FIG. 7 nun 5 is the common jumper point that connects the negative voltage from the 1^{st} oscillator board to the 2^{nd} oscillator board, FIG. 7 num 9 is the 1^{st} oscillator board, FIG. 7 num 8 is the 2nd oscillator board, FIG. 7 num 7 is the termination for the jumper wire providing the positive voltage to the 2^{nd} circuit board, FIG. 7 num 6 is the termination of the jumper wire providing the negative voltage to the 2^{nd} circuit board, FIG. 7 num 12 is the positive voltage jumper for the 2^{nd} circuit board, FIG. 7 num 11 is the negative voltage jumper for the 2^{nd} circuit board.

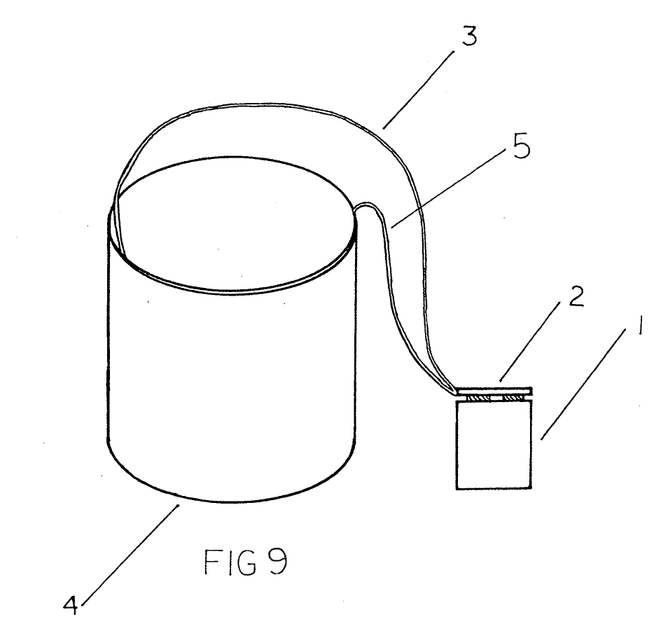

FIG. 9 num 1 is a battery that provides electrical voltage to the connecting cap and wire. FIG. 9 num 2 is a connectable voltage cap that connects the inner wiring loop to the battery, this is also a virtual switch, by pulling the cap off the electrical wiring loses voltage and current flow, and the battery no longer has a load on the electrical circuit and keeps the remaining power in the battery. FIG. 9 num 3 is the conducting wiring that will create a electromagnetic field across the wire, FIG. 9 number 3 also has a electrical nonconductive insulator to isolate the electrical voltage from the water that is to be enhanced. FIG. 9 num 4 is the vessel that will contain the water to be enhanced, and FIG. 9 num 4 will also be the transport means to move the water to the biology to be enhanced. FIG. 9 num 3 is the leading voltage wire loop from the power source, FIG. 9 num 5 is the return wire loop to the battery power source, this wire is looped inside the vessel that contains the water to be enhanced, also this loop being in proximity to angles for incidence will create electromagnetic scalar waves by the appropriate electromagnetic waves canceling each other out with a electromagnetic wave nullification process.

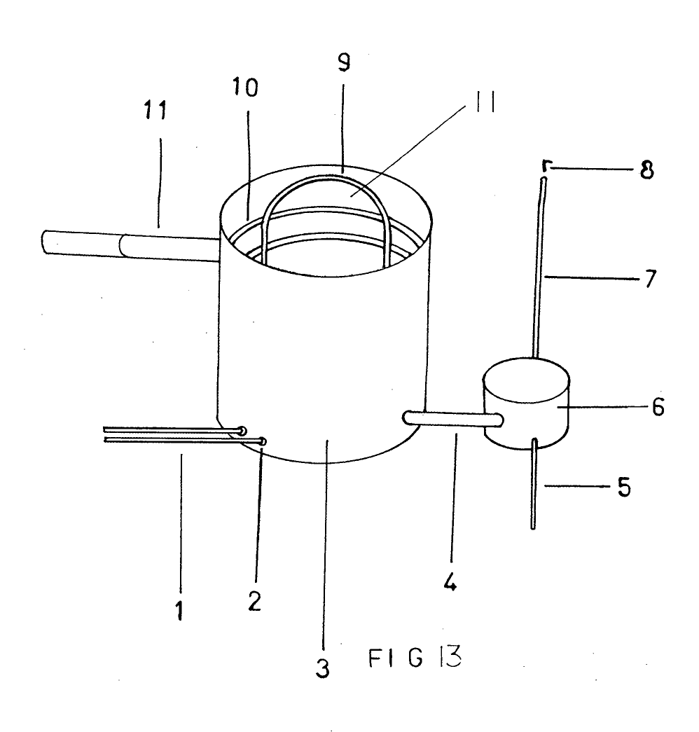

FIG. 11 num 1 is a power supply that takes an AC voltage input and provides electrical voltage to the electrical wiring. FIG. 11 num 2 lead wiring to the vessel that contains water to be enhanced, FIG. 11 num 3 is the return wiring from the vessel that contains water to be enhanced. FIG. 11 num 4 is the vessel that will support the water to be enhanced, and the transport means for moving the water to the biology to be enhanced. FIG. 11 num 5 is showing the lead and return wiring that is looped inside the vessel that contains the water to be enhanced; also this loop being in proximity to each sides of the same wire will create angels of incidence which will create electromagnetic scalar wave by the appropriate electromagnetic waves interference that will cancel each other out with electromagnetic voltage nullification process.

FIG. 13 num 1 is a means for supplying electrical voltages to the vessel that contains water to be enhanced. FIG. 13 num 2 is a hole that provides a means for the electrical conducting wiring to have access to the containment of the water to be magnetized. FIG. 13 num 4 is a means to supply water to a pump to distribute enhanced water to plant biology. FIG. 13 nun 5 is a means to provide power to the pump to provide a means to distribute water to plant biology. FIG. 13 num 6 is a pump that provides pressure to move water though a pipe or means to flow water in an enclosed body. FIG. 13 num 7 is a pipe transport to distribute of the enhanced water to be distributed on plant biology. FIG. 13 num 8 this figure represents a sprinkler head that is commonly used to distribute water on a location that has plant biology to be enhanced.

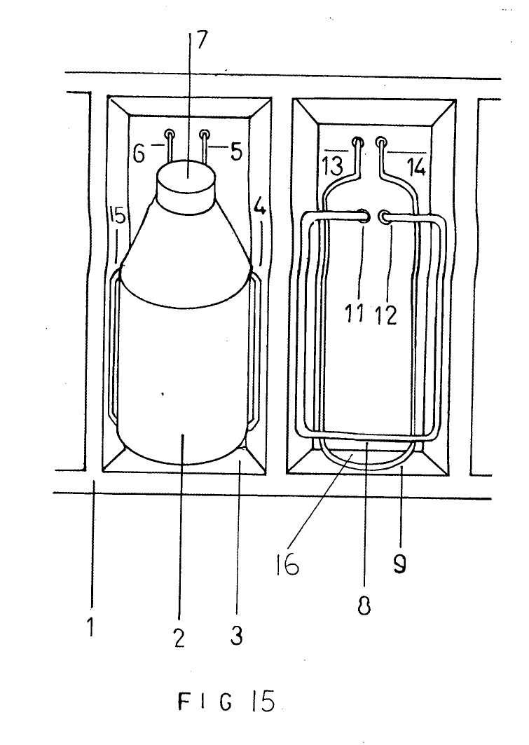

FIG. 15 num 1 is a shelf to provide support for the electrical wiring and electrical and electronic components and bottled water to be enhanced. FIG. 15 num 2 is a bottle that contains water to be enhanced. FIG. 15 num 3 is a flat surface to support the water bottle. FIG. 15 num 4 is an electrical wiring that comprises an electrical conductive wire and a non conducting electrical insulator. FIG. 15 num 15 is an electrical wiring that comprises an electrical conductive wire and a non conducting electrical insulator. FIG. 15 num 5 is a electrical conductive wire and a non conducting electrical insulator. FIG. 15 num 6 is an electrical wiring that comprises a electrical conductive wire and a non conducting electrical insulator. FIG. 15 num 7 is the bottle cap that the water bottle has. FIG. 15 num 8 is showing the electrical loop that is present around the water bottle, and the electrical loop is the wiring that is extended from the oscillator FIG. 17 num 3. FIG. 15 num 9 is showing the electrical loop that is from the oscillator FIG. 17 num 4. FIG. 15 num 11 is the hole that the electrical wiring goes though to the oscillator located on FIG. 17 num 3. FIG. 15 num 12 is the hole that the electrical wiring goes though to the oscillator on FIG. 17 num 3. FIG. 15 num 13 is the hole that the electrical wiring goes though to the oscillator on FIG. 17 num 4. FIG. 15 num 14 is the hole that the electrical wiring goes though to the oscillator on FIG. 17 num 4. FIG. 15 num 16 is the angle of incidence that the electrical loops FIG. 15 num 9 and FIG. 15 num 8 together that create the electromagnetic scalar waves that will be created and the water that is in the bottle FIG. 15 num 2 to be enhanced.

FIG. 17 num 1 is the power source for the power supply. FIG. 17 num 2 is the electrical power supply for the oscillator. FIG. 17 num 3 is the 1^{st} oscillator to create electromagnetic waves. FIG. 17 num 4 is the 2^{nd} oscillator to create electromagnetic waves. FIG. 17 num 25 is the wiring from the oscillator to the cable harness. FIG. 17 num 24 is the electrical harness that will transport the electromagnetic waves to the water to be enhanced. FIG. 17 num 23 is a shelf to provide support for the water bottles FIG. 17 num 20 and FIG. 17 num 18. FIG. 17 num 20 is a representation of a 2½ gallon style water container. FIG. 17 num 18 is a representation of a 2¹/2 gallon style water container. FIG. 17 num 22 is a shelf that will support the water enhancement structure. FIG. 17 num 22 is a shelf that will support the water enhancement structure. FIG. 17 num 15 is a 1 gallon style water container. FIG. 17 num 16 is a 1 gallon style water container. FIG. 17 num 15 is a 1 gallon style water container. FIG. 17 num 14 is a shelf to provide support for the water enhancement structure. FIG. 17 num 12 is a self service size water container; FIG. 17 num 11 is a self service size water container. FIG. 17 num 9 is a service size water container. FIG. 17 number 8 is a self service size water container. FIG. 17 num 6 is the wiring that is the 1^{st} oscillator electromagnetic energy. FIG. 17 number 7 is the wiring that is the 2^{nd} oscillator electromagnetic energy. FIG. 17 num 5 is part of the support structure that supports the shelves and electrical and electronic components.

FIG. 19 is the current wire cage being used to create electromagnetic scalar waves induction in the water vessel. FIG. 1 num 12 and FIG. 19 num 1 is lead wire from the 1^{st} oscillator FIG. 1 num 7 and FIG. 19 num 2 is the return wire from the 1^{st} oscillator FIG. 1 num 8. FIG. 19 num 3 is the lead wire from the 2^{nd} oscillator FIG. 1 num 14.

### ALTERNATIVE METHOD OF PREFERRED EMBODIMENT

An alternative method of creating magnetized water is to separate the water to be magnetized and the electrical circuit to be kept separate from the water vessel. A support means to support the water vessel, an electrical wiring outside the water vessel to induce electromagnetic scalar waves inside the water, an oscillator circuit and power source connected with the support structure of the water bottle

FIG. 15 num 1 is a shelf to provide support for the water bottle containing water to be enhanced. FIG. 15 num 2 is the water bottle containing water to be enhanced. FIG. 15 num 3 is the surface of the shelf that supports the water bottle water to be enhanced. FIG. 15 num 4 is part of the 1^{st} oscillator loop. FIG. 15 num 15 is the other part of the wire loop from the 1^{st} oscillator loop. FIG. 17 num 1 is the appropriate power to be supplied to the FIG. 17 num 2 power supply. FIG. 17 num 2 is the power supply that provides power to the oscillator FIG. 17 num 3, and FIG. 18 num 4. FIG. 17 num 25 is the cable connection that connects the oscillators FIG. 17 num 3 and FIG. 17 num 4 to the electrical cabling and harness to all the appropriate water vessels to be enhanced. FIG. 17 num 23 is the shelf to provide support to the water vessels FIG. 17 num 18 and FIG. 17 num 20. FIG. 17 num 19 is a shelving surface that runs to bottom providing support to the structure and front and back surfaces for running electrical wiring and cabling. FIG. 17 num 22 is a shelf that provides support to the water vessels FIG. 17 num 15, FIG. 17 num 16, FIG. 17 num 17. FIG. 17 num 14 is a shelf that provides support to the water vessels FIG. 17 num 8, FIG. 17 num 9, FIG. 17 num 10, FIG. 17 num 12, and FIG. 17 num 13. FIG. 17 num 5 is a portion of the wiring cable that is separated from the main cable FIG. 17 num 24, this supplies the two oscillator sources of electromagnetic frequencies to each of the water vessels to be enhanced along that shelf FIG. 17 num 6 is the 1^{st} oscillator wiring loop. FIG. 17 num 7 is the 2^{nd} oscillator wiring loop to the vessels that will contain water to be enhanced.

An alternative method of created magnetized water is to have a separate power source to provide power to the electrical circuits and means to power the invention, and vessel that contains a means to supply water to be magnetized, and a pump system to deliver this water to supply water to plants individual or commercial uses.

FIG. 13 num 1 is the electrical power that will provide power to the wiring inside the water vessel FIG. 13 num 3. FIG. 13 num 3 is the water vessel that will contain the water that will be enhanced. FIG. 13 num 4 is the water pipe that will transport the enhanced water contained to the water pump FIG. 13 num 6. FIG. 13 num 5 is the wiring that will provide power to the water pump FIG. 13 num 6, FIG. 13 number 6 is the water pump that will provide sufficient water pressure to distribute enhanced water to the biological plants in the area. FIG. 13 num 8 is a symbol for a sprinkler head to distribute water to the biological plants.

An alternative method of created magnetized water is to use a battery power source to supply voltage to the wiring and a single wire loop inserted in the vessel containing water to be enhanced, into the water to the exposed to electromagnetic waves at angles to create scalar waves inside the water, vessel used to transport the water to be used FIG. 9 num 1 is the battery power source. FIG. 9 num 2 is the cap that connects the batter power to the electrical wiring; FIG. 9, num 6 is also a virtual switch that when the cap is disconnected from the battery power source the voltage is separated from the electrical wiring. FIG. 9 nun 3 is the lead wire providing positive voltage from the battery power source. FIG. 9 num 5 is the return wire providing negative voltage from the battery source. FIG. 9 num 7 is the angle of incidence that creates the electromagnetic scalar waves from the electromagnetic scalar waves created when both sides of the wiring are inside the water vessel and current is running though the wiring.

An alternative method of creation of enhanced water is to use a plug in external power source FIG. 11 num 6 to the power supply FIG. 11 num 1. FIG. 11 num 1 is to provide voltage to the wire loop. FIG. 11 num 3 is the lead wire containing positive voltage from the power supply to the wire loop. FIG. 11 num 2 is the return wire containing negative voltage from the power supply to the wire loop. FIG. 11 num 4 is the vessel that will contain the water to be enhanced. FIG. 11 num 7 is the same vessel that will provide an ability to transport the enhanced water to the biology to be enhanced. FIG. 11 num 5 is the angle of incidence that will be created when the wire loop is placed inside the water vessel, this angle of incidence will be used to create electromagnetic waves are nullified and created into electromagnetic scalar waves.

An alternative method of creation of enhanced water is to use a means to supply ac current along a electrical conductive wire, an electrical insulator, an means to create electromagnetic scalar waves by a single loop inside the water supply, a means to supply water to biological organism.

An alternative method of creation of enhanced water is to use a battery power source attached to the water vessel, an electronic assembly containing oscillator circuit, a means of turning on the electrical components, wiring running along the inside the water vessel containing the water to be enhanced, water vessel to fit inside a refrigerator unit to keep the enhanced water cooled.

### Detailed Description of the Drawings

FIG. 1 num (1) is a power supply that takes provided external power and converts that power to a suitable electrical voltage to drive the oscillator FIG. 1 number (4). FIG. 1 num (5) and FIG. 1 num (6) are the jumpers that provide power from the 1^{st} circuit board to the 2^{nd} oscillator circuit board that will create the electromagnetic induction along the insulated wiring. FIG. 1 number (7) and FIG. 1 num (8) and FIG. 1 num (9) and FIG. 1 num (10), are the electrical loops to provide electromagnetic fields to create induction to the water provided in FIG. 1 num (12). FIG. 1 num (7) and num (8) are placed at a incidence angle with electrical loops FIG. 1 num (9) and num (10) to induce electromagnetic scalar waves inside the provided vessel FIG. 1 num (12)

FIG. 3 num (1) r1 and FIG. 3 num (2) r2 are a voltage dividing resistor network to supply voltage to the oscillator circuit. FIG. 3 num (3) r3 is a emitter transistor resistor voltage to provide voltage to the emitter of the npn transistor. FIG. 3 nun (4) is the npn transistor that provides the change in voltage that will create the oscillator tank frequency. FIG. 3 num (5) 11 is the electrical inductor that helps create the frequency tank circuit. FIG. 3 num (6) w1 is the external wiring that is part of the electrical oscillator tank frequency that provides the electromagnetic induction with the water that is provided in the vessel that is shown as FIG. 1 num (12). FIG. 3 num (7) c2 is a capacitor that helps create the electrical oscillator tank frequency. FIG. 3 num (8) c1 is a capacitor that helps create the electronic oscillator tanks frequency. FIG. 3 num (9) r4 is a resistor that helps create a voltage across the tank circuit to the electrically negative voltage provided from the power supply FIG. 1 num (1). FIG. 3 num (10) is a wire to provide positive voltage to the oscillator, FIG. 3 num (11) is a wire to provide negative voltage to the oscillator, FIG. 3 num (10) is a electrical conductive wiring that provides positive voltage from the power supply FIG. 1 num (1), FIG. 3 num (11) is a electrical conductive wiring that provides negative voltage from the power supply, FIG. 3 num (10) also has a non conductive electrical insulation that provides insulation across the electrical wiring, FIG. 3 num (10) also has a non conductive electrical insulation that provides insulation across the electrical wiring

FIG. 3 num (6) w1 is the electrical conduction wiring that is surrounded with a non conducting electrical insulator. This external wire is part of the oscillator tank circuit comprising and 11, c1, c2, components this tank circuit provides the electromagnetic fields along the wiring FIG. 3 num (6) w1 to the vessel FIG. 1 num (12) that contains the water to be magnetized. The two electrical loops FIG. 1 num (7) and num (8) plus FIG. 1 num (9) and num (10) are shown with a angle of incidence FIG. 1 num (13) that shows the two electrical wires are placed to create electromagnetic scalar waves induction with the water in the vessel FIG. 1 num (12). Both electromagnetic oscillator circuits FIG. 1 num (4) and FIG. 1 num (14) are using the same electronic value components to create electromagnetic waves of same relative frequency to cancel each other out with the appropriate polarities of the two electromagnetic waves being inducted with the water in the vessel FIG. 1 num (12). FIG. 1 num (11) is the bottom of the vessel that contains the water to be magnetized. FIG. 1 num (15) is the prongs that connect the power supply to an appropriate outlet

FIG. 5 num (1) is a resistor to provide voltage divider network, FIG. 5 num (2) is a resistor to provide voltage divider network, FIG. 5 num (3) is the npn emitter resister to provide voltage to npn transistor. FIG. 5 num (4) is a npn transistor to create the oscillations on the circuit board and external wiring, FIG. 5 num (7) is a capacitor to create the oscillations in the circuit board, FIG. 5 num (8) is a capacitor to create oscillations in the circuit board, FIG. 5 num (5) is a inductor to create oscillation frequency in the circuit board, FIG. 5 num (9) is a resistor to develop voltage in the circuit board, FIG. 5 num (10) is the hole in the circuit board for the emitter leg of the transistor to be place through, FIG. 5 num (11) is the hole that the base of the transistor leg to be placed though, FIG. 5 num (12) is the hole that the collector of the transistor leg is to be placed though. FIG. 5 nun (13) is a circuit board backing that provides a means to support the electronic components.

FIG. 7 num (1) is a power supply that provides direct current voltage to the two oscillator boards, the FIG. 7 num (15) has a alternate current input voltage that is provided externally to the power supply, FIG. 7 num (1) is also an on off virtual switch by disconnection connection from a wall socket or any another means of putting the power supply into a compatible voltage source, fig (7) num 2 is the positive voltage wiring to the circuit board, FIG. 7 num (3) is the negative voltage wiring to the circuit board, FIG. 7 num (4) is the common jumper point that connects the positive voltage from Ist oscillator board to the 2^{nd} oscillator board, FIG. 7 num (5) is the common jumper point that connects the negative voltage from the 1^{st} oscillator board to the 2^{nd} oscillator board, FIG. 7 num (9) is the 1^{st} oscillator board, FIG. 7 number 8 is the 2^{nd} oscillator board, FIG. 7 num (7) is the termination for the jumper wire providing the positive voltage to the 2^{nd} circuit board, FIG. 7 num (6) is the termination of the jumper wire providing the negative voltage to the 2^{nd} circuit board, FIG. 7 num (10) is the positive voltage jumper for the 2nd circuit board, FIG. 7 num (11) is the negative voltage jumper for the 2^{nd} circuit board.

### Theory of Operation

The resultant water is magnetized with a new synergistic quality that enhances the biology with the water has been assimilated. The new synergistic reaction occurs when electromagnetic scalar waves are inducted with water.

This inventor believes that the scalar energy, that is created by using electromagnetic scalar waves, access the water molecule in a way to create a higher vibration energy level that is already present in the water molecule. This higher level of energy biology can absorb with positive results. Current science cannot explain the synergistic effect, the current science only shows the normal chemistry reactions with biology and water, and known electromagnetic energy with water is currently limited to kinetic means of kinetic energy induction. Example a microwave oven using electromagnetic waves of energy to induce kinetic energy to heat water for example. This inventor does not wish to be bound by this theory

The resultant water using electromagnetic scalar waves creates a new synergistic quality that enhances the biology with the water has been assimilated.

The inventor has no exact explanation of why the two qualities of electromagnetism and water creates this phenomena.

1. A new patent comprising:
means for method of creation of magnetized water for plant mammal and human consumption absorbing and assimilation of water to support restore and give enhancement to biological function;
means for power to oscillator;
means for electrical conducting wire;
means for electrical insulation for electrical wiring;
means for electromagnetic scalar waves using electromagnetic energy; and
means for transport energized enhanced water to biological life to be enhanced.

2. A new patent comprising:
means for electrical conducting wire;
means for electrical insulation for electrical wiring;
means for creation of electromagnetic scalar waves using electromagnetic energy;
means for transport energized enhanced water to biological life to be enhanced; and
means for electrical power to conductive wiring.

3. A new patent comprising:
means for variation of biological enhancement per individual biological organism

4. The new patent in accordance with claim 1, wherein said means for method of creation of magnetized water for plant mammal and human consumption absorbing and assimilation of water to support restore and give enhancement to biological function comprises a water magnetizer.

5. The new patent in accordance with claim 1, wherein said means for means to provide power to oscillator comprises a power supplied.

6. The new patent in accordance with claim 1, wherein said means for means to provide electrical conducting wire comprises an electrical conductor.

7. The new patent in accordance with claim 1, wherein said means for means to provide electrical insulation for electrical wiring comprises an electrical insulator.

8. The new patent in accordance with claim 1, wherein said means for means to provide electromagnetic scalar waves using electromagnetic energy comprises an electromagnetic scalar waves.

9. The new patent in accordance with claim 1, wherein said means for means to transport energized enhanced water to biological life to be enhanced comprises a water transport.

10. The new patent in accordance with claim 2, wherein said means for means to provide electrical conducting wire comprises an electrical conductor.

11. The new patent in accordance with claim 2, wherein said means for means to provide electrical insulation for electrical wiring comprises an electrical insulator.

12. The new patent in accordance with claim 2, wherein said means for means to provide electromagnetic scalar waves using electromagnetic energy comprises an electromagnetic scalar waves.

13. The new patent in accordance with claim 2, wherein said means for means to transport energized enhanced water to biological life to be enhanced comprises a water transport.

14. The new patent in accordance with claim 2, wherein said means for electrical power to conductive wiring comprises an electrical power.

15. A new patent comprising:
an electrical conductor, for means to provide electrical conducting wire;
an electrical insulator, for means to provide electrical insulation for electrical wiring;
an electromagnetic scalar waves, for means to provide electromagnetic scalar waves using electromagnetic energy;
a water transport, for means to transport energized enhanced water to biological life to be enhanced; and
an electrical power, for electrical power to conductive wiring.
